(19) United States
(12) Patent Application Publication
(10) Pub. No.: US 2026/0171720 A1
(43) Pub. Date: Jun. 18, 2026

(54) CONNECTOR

(71) Applicant: SUMITOMO WIRING SYSTEMS, LTD., Mie (JP)

(72) Inventor: Ryohei TSUTSUI, Mie (JP)

(21) Appl. No.: 19/356,236

(22) Filed: Oct. 13, 2025

(30) Foreign Application Priority Data
Oct. 16, 2024 (JP) 2024-180693

(51) Int. Cl. H01R 13/639

(52) U.S. Cl. CPC H01R 13/639

(57) ABSTRACT

A lever includes a lever lock part that is pivoted in a first direction relative to a housing, and is capable of being fitted to the housing at a fitted position. A cover includes a locking part that is slid on and attached to the housing in a second direction that intersects the first direction, and is capable of being locked to the housing at an attached position. One of the lever and the cover includes a recess recessed in the first direction, and the other of the lever and the cover includes a protrusion protruding in the first direction. The protrusion is disposed at an interior portion of the recess at the attached position and the fitted position.

### CROSS-REFERENCE TO RELATED APPLICATIONS

This application is based on and claims priority from Japanese Patent Application No. 2024-180693, filed on Oct. 16, 2024, with the Japan Patent Office, the disclosure of which is incorporated herein in its entirety by reference.

### TECHNICAL FIELD

The present disclosure relates to a connector.

### BACKGROUND

The connector described in JP 2020-166940 A includes a connector housing, a cover that covers a wire extending from the connector housing, a lever that is supported so as to be pivotable from a fitting start position toward a fitting completion position relative to the connector housing. The lever includes a positioning recess. A plurality of reinforcing ribs protrude from the cover. A portion of each of the reinforcing ribs is configured as a positioning part. When the lever is at the fitting completion position, the positioning part is disposed at an interior portion of the corresponding positioning recess. At the fitting completion position, an abutment surface of the positioning recess comes into contact with an abutment receiving surface of the corresponding positioning part, whereby the cover is positioned in the left-right direction (the direction of sliding of the cover relative to the connector housing) relative to the connector housing. JP 2017-054584 A and JP 2016-091778 A describe connectors capable of detecting that a lever has not reached a fitted position (a position at which the housing is properly fitted to a counterpart housing) relative to a housing.

### SUMMARY

In JP 2020-166940 A, in a case where, for example, the lever has not reached the fitting completion position relative to the housing in a state in which the cover is not properly attached to the housing, it is difficult to detect this state (half-fitted state) of the lever. In contrast, according to JP 2017-054584 A and JP 2016-091778 A, the half-fitted state can be detected according to whether the lever is properly locked to the housing. However, the connectors do not include a member corresponding to the cover, and therefore the state of the cover relative to the housing cannot be detected in the first place.

Therefore, an object of the present disclosure is to provide a connector capable of detecting the states of both a cover and a lever relative to a housing.

A connector according to the present disclosure includes: a housing; a cover configured to cover a wire extending from the housing; and a lever configured to be supported so as to be pivotable in a first direction from an initial position to a fitted position relative to the housing, wherein the lever includes a lever lock part capable of being locked to the housing at the fitted position, the cover is slid on and attached to the housing in a second direction that intersects the first direction, and includes a locking part capable of being locked to the housing at an attached position, one of the lever and the cover includes a recess recessed in the first direction, and the other of the lever and the cover includes a protrusion protruding in the first direction, the protrusion is disposed at an interior portion of the recess at the attached position and the fitted position, and one of the lever and the cover includes an elastic part that comes into contact with the other of the lever and the cover while reaching the fitted position from the initial position.

According to the present disclosure, it is possible to provide a connector capable of detecting the states of both a cover and a lever relative to a housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to Embodiment 1.

FIG. 2 is a plan view of the connector according to Embodiment 1.

FIG. 3 is a cross-sectional view of the connector according to Embodiment 1 taken along the line A-A in FIG. 2.

FIG. 4 is a cross-sectional view of the connector according to Embodiment 1 taken along the line B-B in FIG. 2.

FIG. 5 is a front view of a housing of the connector according to Embodiment 1.

FIG. 6 is a rear view of the housing of the connector according to Embodiment 1.

FIG. 7 is a bottom view of a lever of the connector according to Embodiment 1.

FIG. 8 is an enlarged perspective view of the connector according to Embodiment 1, showing a lever lock part of the lever and a peripheral portion thereof as viewed obliquely from below.

FIG. 9 is a perspective view of a cover of the connector according to Embodiment 1 as viewed obliquely from the rear.

FIG. 10 is a perspective view of the cover of the connector according to Embodiment 1 as viewed obliquely from the front.

FIG. 11 is an enlarged cross-sectional side view of the connector according to Embodiment 1, showing a state in which a protrusion is disposed at an interior portion of a recess, and an elastic part is elastically deformed as a result of coming into contact with a distal end portion of the protrusion.

FIG. 12 is an enlarged cross-sectional side view of the connector according to Embodiment 1, showing a state in which the protrusion interferes with an opening end face of the recess when the cover has not reached an attached position relative to the housing, as viewed from obliquely from below.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, embodiments of the present disclosure will be listed and described.
(1) A connector according to the present disclosure includes: a housing; a cover configured to cover a wire extending from the housing; and a lever configured to be supported so as to be pivotable in a first direction from an initial position to a fitted position relative to the housing, wherein the lever includes a lever lock part capable of being locked to the housing at the fitted position, the cover is slid on and attached to the housing in a second direction that intersects the first direction, and includes a locking part capable of being locked to the housing at an attached position, one of the lever and the cover includes a recess recessed in the first direction, and the other of the lever and the cover includes a protrusion protruding in the first direction, the protrusion is disposed at an interior portion of the recess at the attached position and the fitted position, and one of the lever and the cover includes an elastic part that comes into contact with the other of the lever and the cover while reaching the fitted position from the initial position.

When the cover reaches the attached position relative to the housing, and the lever is at the fitted position relative to the housing, the protrusion is disposed at an interior portion of the recess. In a state in which the elastic part is elastically deformed as a result of coming into contact with the other of the lever or the cover, the lever lock part becomes capable of being locked to the housing.

In contrast, when the cover has not reached the attached position relative to the housing, the protrusion interferes with the interference face of the one of the lever or the cover without being disposed at the interior portion of the recess. This make it possible to detect that the cover has not reached the attached position relative to the housing.

When the cover has reached the attached position relative to the housing, and the lever remains at a position midway from the initial position to the fitted position, the elastic part comes into contact with the contact face of the other, and the lever is pushed back by the elastic force of the elastic part. By a worker confirming this state, it is possible to detect that the lever is in a half-fitted state in which the lever has not reached the fitted position.
(2) In the connector according to (1) above, it is preferable that the elastic part is provided at one of the interior portion of the recess and a distal end portion of the protrusion, and comes into contact with the other of the interior portion and the distal end portion while reaching the fitted position from the initial position.

With the configuration according to (2) above, the elastic part is included within the formation region of one of the recess and the protrusion, and it is therefore possible to suppress an increase in size and complexity of the shape of the one (the lever or the cover) on which the elastic part is provided.
(3) In the connector according to (2) above, it is preferable that the elastic part is provided in the interior portion of the recess.

With the configuration according to (3) above, the elastic part is less likely to come into contact with an external foreign object in the interior portion of the recess, thus making it possible to prevent a situation where the elastic force of the elastic part is impaired.
(4) In the connector according to (3) above, it is preferable that an abutment surface that comes into contact with the elastic part at the attached position and the fitted position is provided on an innermost side of the interior portion of the recess in the first direction.

With the configuration according to (4) above, as a result of the elastic part coming into contact with the abutment surface, further elastic deformation of the elastic part can be suppressed. As a result, it is possible to more reliably prevent a situation where the elastic force of the elastic part is impaired.
(5) In the connector according to (3) or (4) above, it is preferable that the elastic part has a shape extending in a third direction that intersects the first direction and the second direction, one end of the elastic part in the third direction is fixed to one face of the recess, another end of the elastic part in the third direction is a free end, and another end end face of the recess that is opposed to the one face is open as an open face.

With the configuration according to (5) above, the elastic part can be molded using a mold that moves from the open face toward the other side in the third direction.
(6) In the connector according to one of (1) or (5) above, it is preferable that the elastic parts are provided on opposite sides of the lever with the lever lock part interposed therebetween as viewed in the first direction.

With the configuration according to (6) above, the lever at the fitted position is biased in a direction in which the locking to the cover is strengthened by the elastic parts on the opposite sides with the lever lock part interposed therebetween. Accordingly, the lever lock part is locked to the cover without rattling.

### Details of Embodiments of the Present Disclosure

Specific examples of the present disclosure will be described below with reference to the drawings. It should be noted that the present invention is not limited to these examples, and is intended to include all modifications which fall within the scope of the claims and the meaning and scope of equivalents thereof.

### (Embodiment 1)

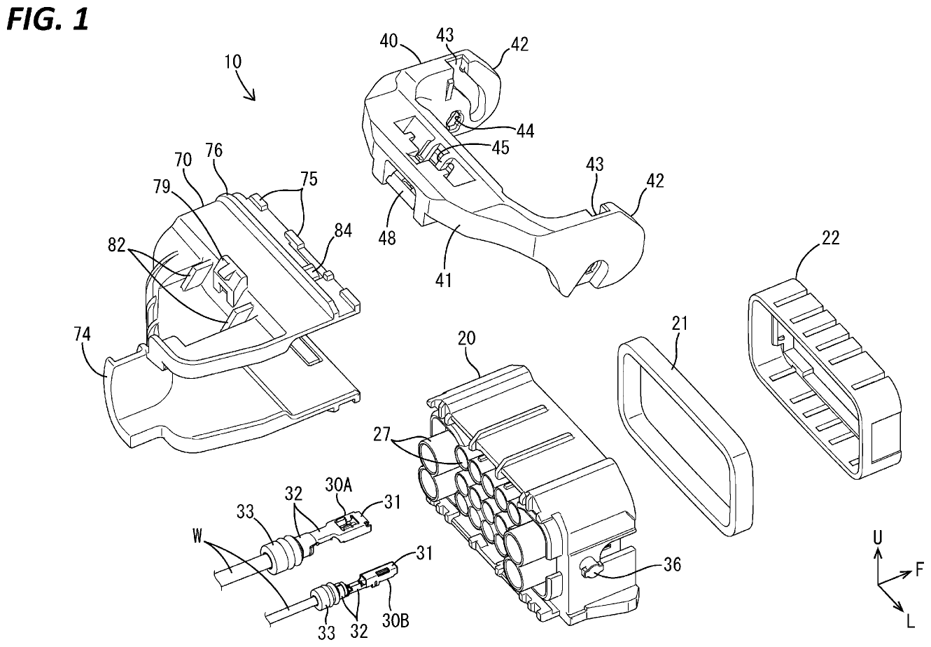

As shown in FIG. 1, a connector 10 according to Embodiment 1 includes a housing 20, a lever 40, and a cover 70. The housing 20 is fittable to a counterpart connector 100. Terminal fittings 30A and 30B are accommodated in the housing 20. A seal ring 21 and a pressing member 22 are attached to the housing 20. In the following description, as for the front-rear direction, a direction in which the housing 20 is fitted to the counterpart connector 100 is defined as the front side. The up-down direction is defined with reference to the up-down direction in FIG. 1. The references of the directions do not necessarily coincide with the references of the corresponding directions in a state in which the connector 10 is mounted in a vehicle or the like (not shown). Reference characters F, L, and U respectively indicate the front side, the left side, and the upper side in FIG. 1.

### (Housing 20, Terminal Fittings 30A and 30B, Pressing Member 22 and Seal Ring 21)

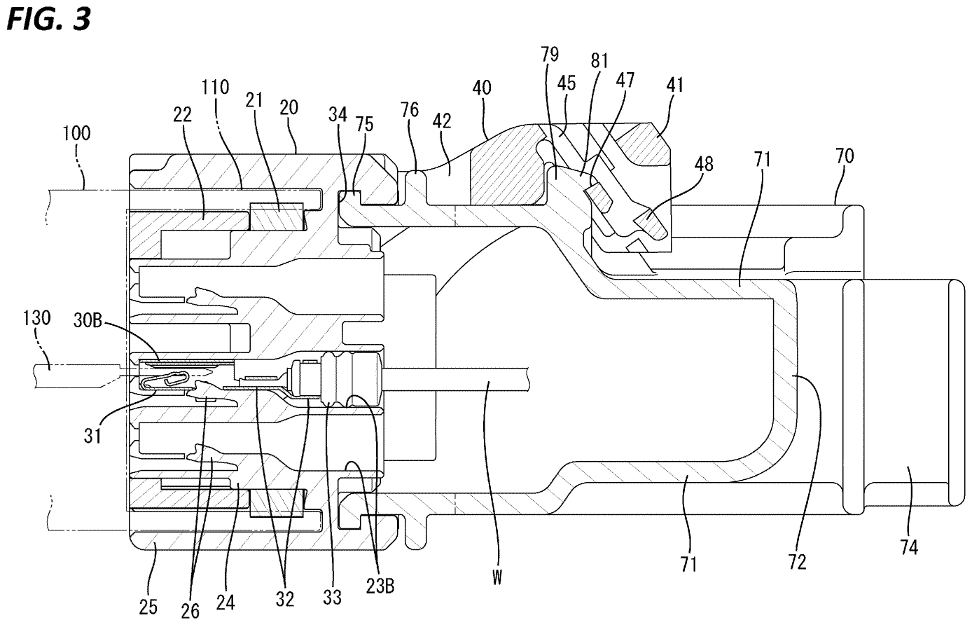

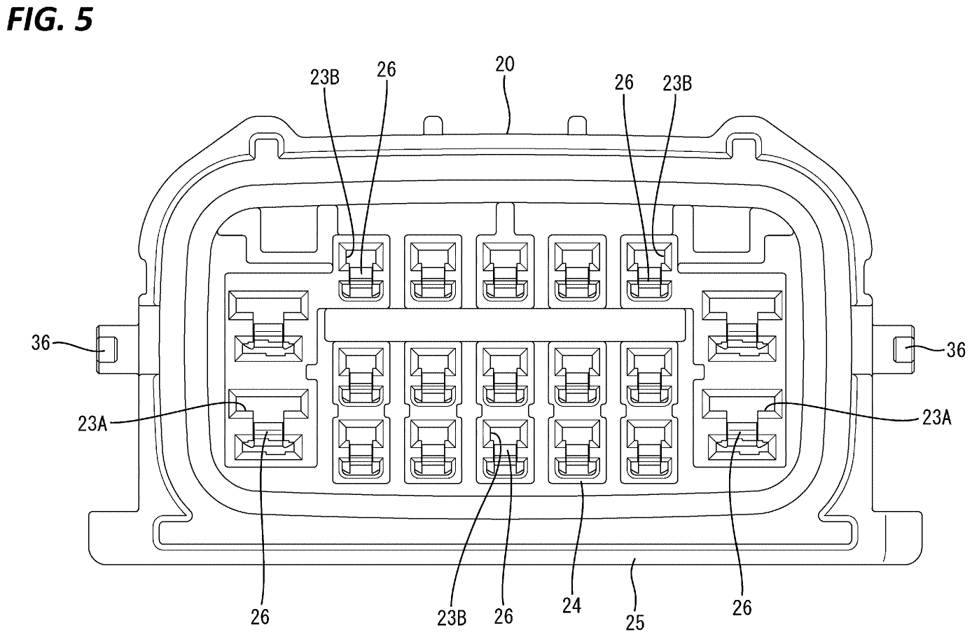

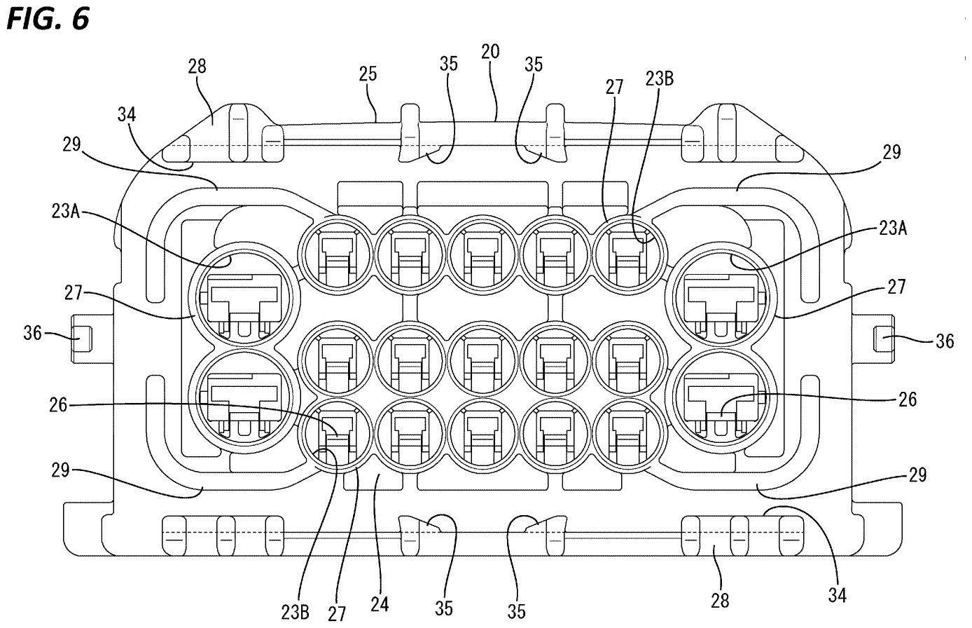

The housing 20 is made of synthetic resin. As shown in FIGS. 3 and 5, the housing 20 includes a housing body 24 including a plurality of cavities 23A and 23B, and a fitting tube part 25 that covers the outer circumference of the housing body 24. A hood part 110 of the counterpart connector 100 is fitted between the housing body 24 and the fitting tube part 25. The cavities 23A and 23B include small cavities 23B located at an intermediate portion of the housing body 24 (portions other than opposite end portions) in the left-right direction, and large cavities 23A located at opposite end portions of the housing body 24 in the left-right direction. The opening diameter of the large cavities 23A is larger than the opening diameter of the small cavities 23B. An elastically deformable lance 26 protrudes from an inner surface of each of the cavities 23A and 23B. As shown in FIG. 3, the terminal fittings 30A and 30B are inserted into the cavities 23A and 23B from the rear side (a terminal fitting 30B is disclosed in FIG. 3). The terminal fittings 30A and 30B are locked to the lances 26, whereby dislodgement of the terminal fittings 30A and 30B from the cavities 23A and 23B is suppressed. A large-sized terminal fitting 30A is inserted into each of the large cavities 23A. A small-sized terminal fitting 30B is inserted into each of the small cavities 23B. As shown in FIGS. 1 and 6, a plurality of tube parts 27 protrude from a rear surface of the housing body 24. The tube parts 27 have a cylindrical shape, and define rear end portions of the cavities 23A and 23B.

All of the large-sized and small-sized terminal fittings 30A and 30B are formed by subjecting a conductive metal plate to bending or the like. As shown in FIG. 1, each of the terminal fittings 30A and 30B includes a tubular connection part 31, and a barrel part 32 located rearward of the connection part 31. As shown in FIG. 3, a counterpart terminal fitting 130 is inserted into the connection part 31 for connection. The barrel part 32 is crimped, together with a rubber stopper 33, to a terminal portion of the corresponding wire W. In a state in which the terminal fittings 30A and 30B are accommodated in the cavities 23A and 23B, the rubber stoppers 33 are in close contact with inner circumferential surfaces of the corresponding tube parts 27, and the wires W extend from the housing body 24 to the rear side.

The pressing member 22 is made of synthetic resin. As shown in FIG. 1, the pressing member 22 has a tube shape, and is open in the front-rear direction. As shown in FIG. 3, the pressing member 22 is attached to the housing body 24 from the front side, and is disposed so as to cover an outer circumferential surface of the housing body 24.

The seal ring 21 is made of rubber such as silicone rubber, and has a ring shape as shown in FIG. 1. As shown in FIG. 3, the seal ring 21 is attached to the outer circumferential surface of the housing body 24. The pressing member 22 suppresses forward dislodgement of the seal ring 21 on the outer circumferential surface of the housing body 24. The seal ring 21 is radially sandwiched between the hood part 110 of the counterpart connector 100 (not shown) and the housing body 24, and provides waterproofing between the connector 10 and the counterpart connector 100.

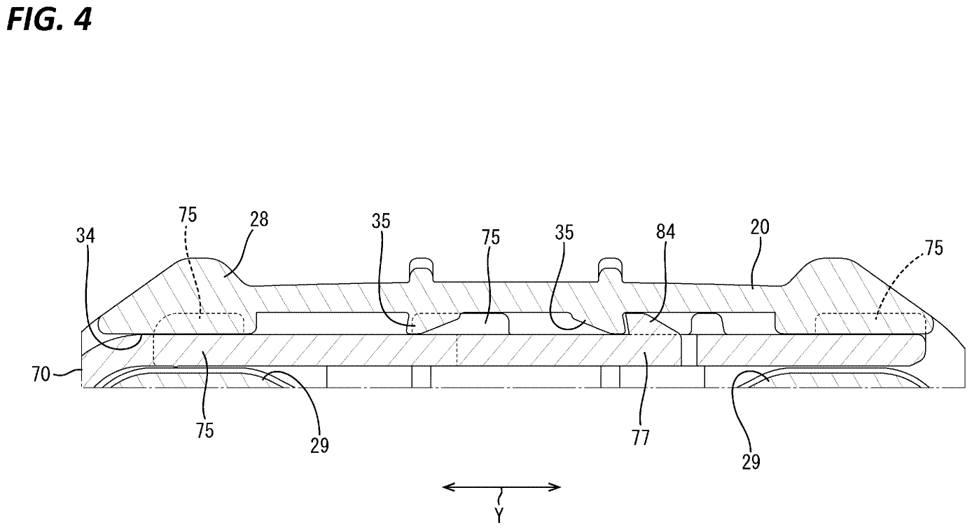

As shown in FIG. 6, on a rear surface of the housing 20, outer guide ribs 28 protrude from opposite end portions in the up-down direction with the tube parts 27 interposed therebetween. The outer guide ribs 28 extend in the left-right direction along an upper end portion and a lower end portion, respectively, of the fitting tube part 25. Inner guide ribs 29 protrude from opposite end portions of the rear surface of the housing 20 in the left-right direction. The inner guides rib 29 extend while surrounding, from the upper and lower sides, large-diameter tube parts 27 formed at opposite end portions in the left-right direction of the rear surface of the housing 20. Guide grooves 34 that are open in the left-right direction are defined between the outer guide ribs 28 and the corresponding inner guide ribs 29. A pair of stop parts 35 are formed at an intermediate portion of each of the outer guide ribs 28 in the left-right direction of so as to be spaced apart in the left-right direction. Each of the stop parts 35 has a pawl shape, and protrudes to the corresponding guide groove 34 from a rear end portion (distal end portion in the protruding direction) of the outer guide rib 28. As shown in FIGS. 3 and 4, cover guide parts 75, which will be described later, of the cover 70 are inserted into the guide grooves 34. As a result of the cover guide parts 75 moving along the guide grooves 34, the cover 70 is slid on and attached to the housing 20. As a result of locking parts 77, which will be described later, of the cover 70 being locked to the stop parts 35, the cover 70 is held in an attached position relative to the housing 20. As shown in FIGS. 5 and 6, a pair of support shafts 36 respectively protrude from opposite outer surfaces of each of the fitting tube parts 25 in the left-right direction. The lever 40 is pivotable between an initial position and a fitted position relative to the housing 20 while being supported by the support shafts 36.

### (Lever 40)

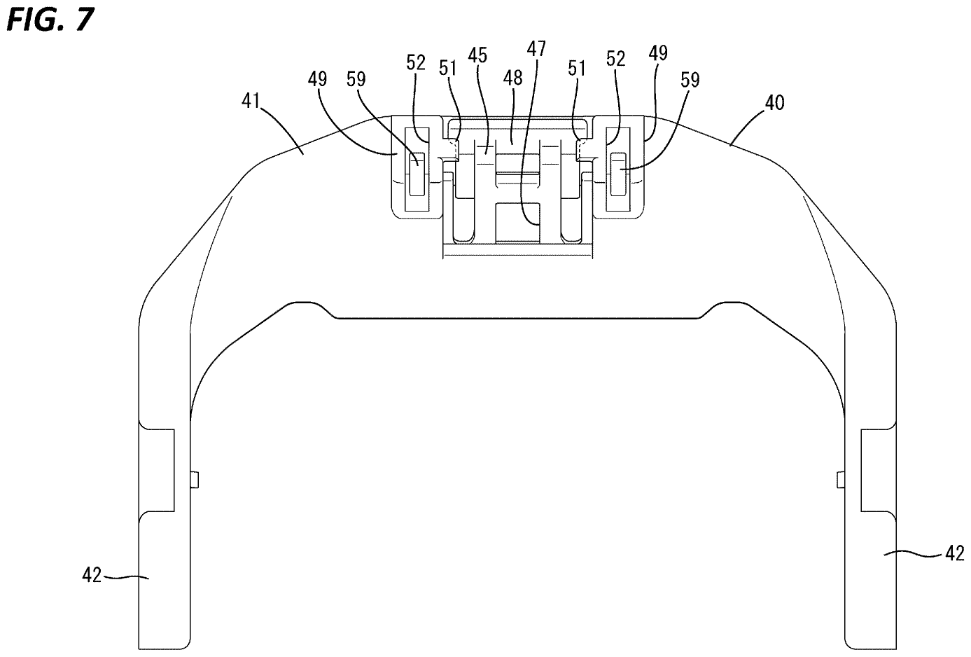

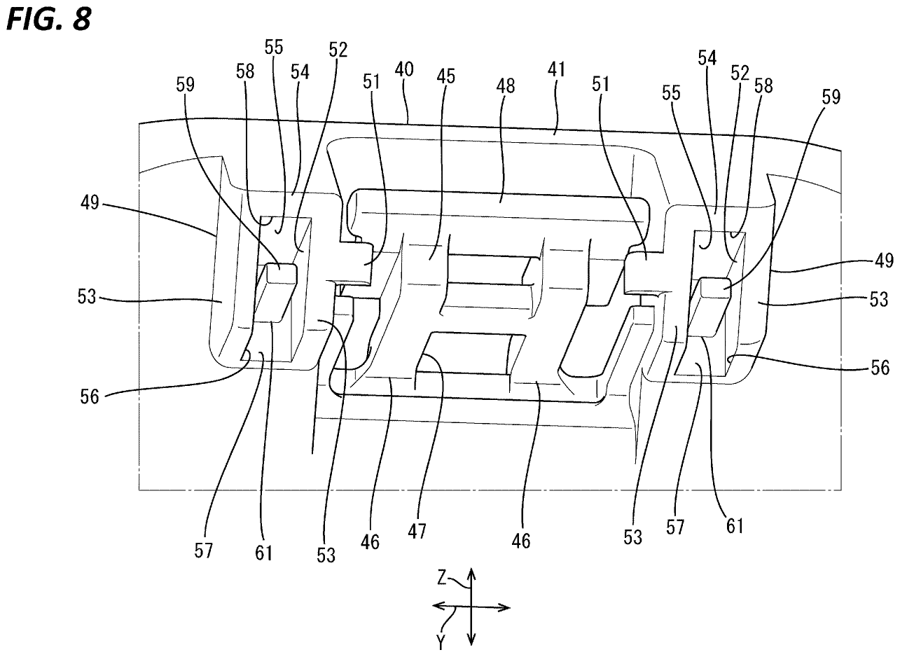

The lever 40 is made of synthetic resin. As shown in FIG. 7, the lever 40 has an overall gate shape. The lever 40 includes an operation part 41 extending in the left-right direction, and a pair of cam plate parts 42 protruding from opposite end portions of the operation part 41 in the left-right direction while being opposed to each other. As shown in FIG. 1, cam grooves 43 are formed in inner surfaces (opposed surfaces on which the cam plate parts 42 are opposed to each other) of the corresponding cam plate parts 42. In addition, a shaft hole 44 is formed in each of the cam plate parts 42. A lever lock part 45 is formed at an intermediate portion of the operation part 41 in the left-right direction. As shown in FIG. 8, the lever lock part 45 protrudes in a cantilevered manner from a base part 46 in an intermediate portion of the operation part 41 in the left-right direction. The lever lock part 45 is elastically deformable with the base part 46 as a support point. A lock hole 47 is formed in the lever lock part 45. A pressing-releasing part 48 is formed at a distal end portion of the lever lock part 45 in the protruding direction. The pressing-releasing part 48 has a portion that bulges outward in the left-right direction.

As shown in FIGS. 7 and 8, the operation part 41 includes a pair of protection walls 49 protruding from opposite sides thereof in the left-right direction with the lever lock part 45 interposed therebetween. The protection walls 49 are disposed so as to cover the lever lock part 45 from opposite sides in the left-right direction. Each of the protection walls 49 includes a stopper part 51 protruding toward the lever lock part 45 side. The portions of the pressing-releasing part 48 that bulge outward in the left-right direction come into contact with the stopper parts 51 of the protection walls 49, whereby further elastic deformation of the lever lock part 45 is suppressed. The lever 40 is attached to the housing 20 from above, and the support shafts 36 are fittingly inserted into the shaft holes 44 of the cam plate parts 42. Also, the lever 40 is supported so as to be pivotable between the initial position and the fitted position relative to the housing 20 around the support shafts 36 (shaft holes 44). At the initial position, the operation part 41 is disposed above the housing 20, and the entrance of each of the cam grooves 43 of the cam plate parts 42 is disposed so as to be directed forward. When the lever 40 is at the initial position, fitting to the counterpart connector 100 is started. At the start of fitting, cam followers (not shown) of the counterpart connector 100 are inserted into the entrances of the cam grooves 43 of the cam plate parts 42. In that state, the lever 40 is pivoted from the initial position toward the fitted position while the operation part 41 is being pinched. In the process of pivoting the lever 40, the cam followers slide on the groove surfaces of the cam grooves 43 of the cam plate parts 42, whereby the fitting between the connector 10 and the counterpart connector 100 proceeds with a low fitting force. When the lever 40 reaches the fitted position, the fitting between the housing 20 and the counterpart connector 100 is completed, and the terminal fittings 30A and 30B are connected in a proper state to the corresponding counterpart terminal fittings 130. As shown in FIG. 3, at the fitted position, the operation part 41 approaches the housing 20, and the lever lock part 45 is locked to a cover lock part 79, which will be described later, of the cover 70. Accordingly, the pivoting of the lever 40 is suppressed, and the connector 10 and the counterpart connector 100 are held in a fitted state. When the connector 10 and the counterpart connector 100 in the fitted state are separated from each other, the pressing-releasing part 48 is pressed from above, thus releasing the locking between the lever lock part 45 and the cover lock part 79.

As shown in FIGS. 7 and 8, recesses 52 are formed in an intermediate portion (portion excluding opposite end portions in the left-right direction) of the operation part 41 in the left-right direction. A pair of recesses 52 are disposed on opposite sides in the left-right direction with the lever lock part 45 interposed therebetween. The recesses 52 are recessed in the protection wall 49. As shown in FIG. 8, each of the protection walls 49 includes a pair of side wall parts 53 that are opposed to each other in the left-right direction, and an upper wall part 54 that connects the side wall parts 53 with each other, and the recesses 52 are defined between the side wall parts 53 and the upper wall part 54.

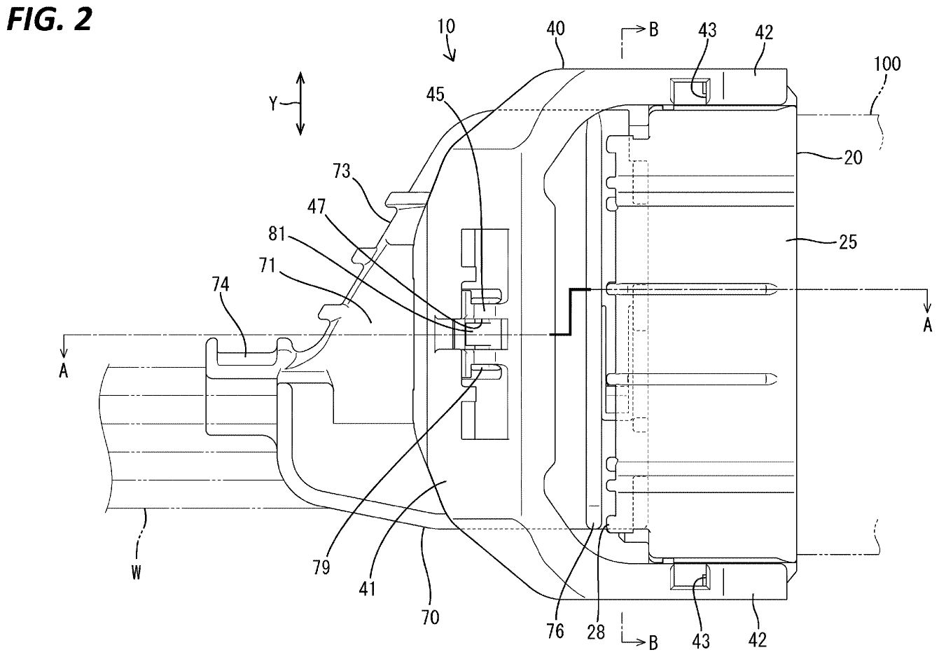

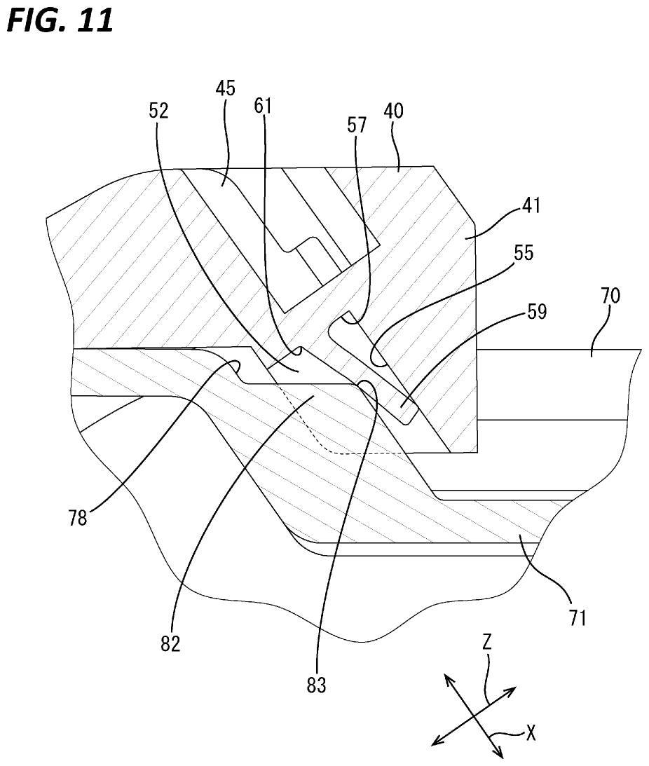

The inner surface of each of the upper wall parts 54 is configured as a contact surface 55 that faces the corresponding recess 52, and that is opposed to an elastic part 59, which will be described later, in the direction of elastic deformation of the elastic part 59. When a first direction X is the pivoting direction of the lever 40 (see FIG. 11), a second direction Y is the left-right direction, which is the sliding direction of the cover 70 relative to the housing 20 (see FIGS. 2, 4 and 8), and a third direction Z is a direction that intersects the first direction X and the second direction Y (see FIGS. 8 and 11), each of the abutment surfaces 55 is located on one end face (the innermost face) of the corresponding recess 52 in the third direction Z as shown in FIG. 8. The other end face of each of the recesses 52 in the third direction Z is open as a receiving opening 56 that is opposed to the corresponding abutment surface 55. Protrusions 82, which will be described later, of the cover 70 are inserted into the corresponding recesses 52 from the corresponding receiving openings 56, and the side wall parts 53 suppress positional displacement in the second direction Y. One end face (the innermost face) of each of the recesses 52 in the first direction X is configured as one face 57 that is orthogonal to the corresponding abutment surface 55. The other end face of the recess 52 in the first direction X is open as an open face 58 that is opposed to the one face 57.

As shown in FIG. 8, elastic parts 59 protrude from an intermediate portion of the operation part 41 in the left-right direction. A pair of elastic parts 59 are disposed on opposite sides of the lever lock part 45 in the left-right direction. Each of the elastic parts 59 protrudes from an interior portion of the corresponding recess 52. The elastic part 59 has the shape of a cantilever beam protruding toward the other side in the first direction X from the one face 57 of the recess 52. A free end (the other end in the first direction X) of the elastic part 59 is disposed so as to face the open face 58 inside the corresponding recess 52. That is, the free end of the elastic part 59 is visible from the open face 58. As in the case of the lever lock part 45, the elastic part 59 is elastically deformable in the third direction Z.

Each of the elastic parts 59 is elastically deformable, using a basal part 61 that is connected with the one face 57 of the corresponding recess 52 as a support point. Also, the elastic part 59 has a rectangular cross section, and is spaced apart from each of the side wall parts 53 and the upper wall part 54. As shown in FIG. 11, the elastic part 59 is opposed to the corresponding abutment surface 55 in the third direction Z, which is the direction of its elastic deformation, and is capable of coming into contact with the abutment surface 55 during elastic deformation.

### (Cover 70)

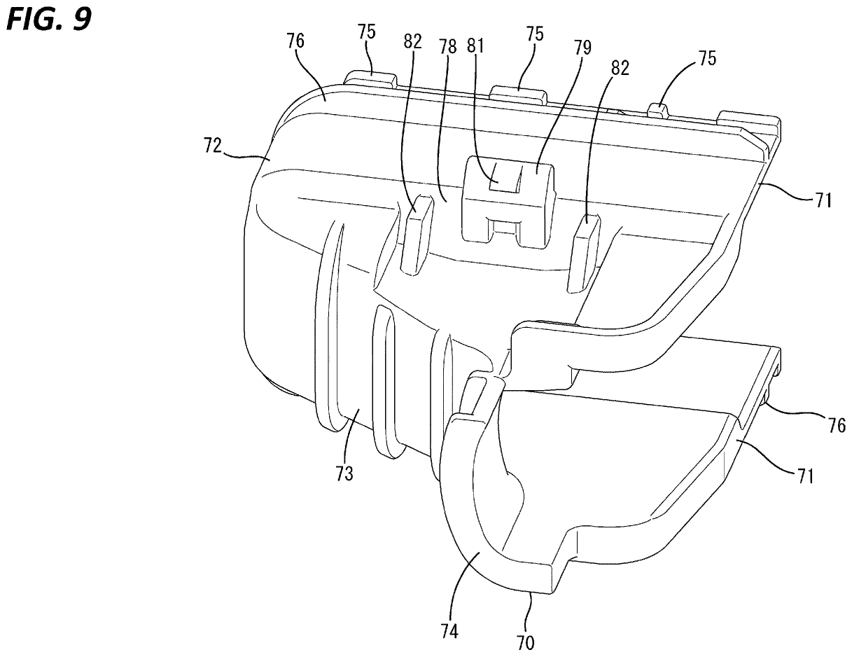

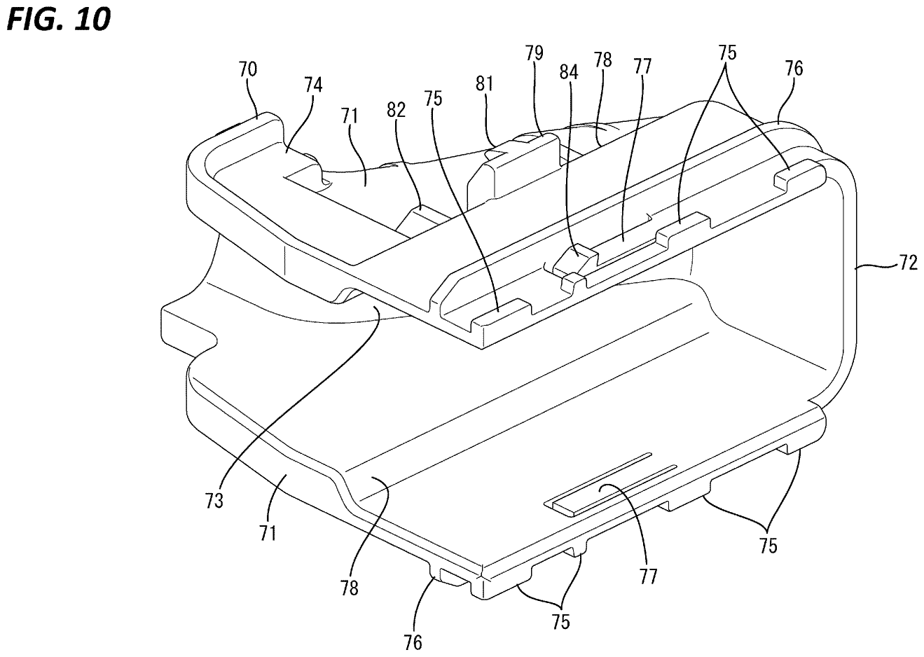

The cover 70 is made of synthetic resin. As shown in FIGS. 9 and 10, the cover 70 has an overall cap shape. The cover 70 includes a pair of opposed plate parts 71 that are opposed to each other in the up-down direction, a side plate part 72 that is connected with one end portion (a right end portion in FIG. 10) of the opposed plate parts 71 in the second direction Y and closes one end face of the cover 70 in the second direction Y, and a back plate part 73 that is connected with a rear end portion of each of the opposed plate parts 71 and the side plate part 72 and closes a rear surface of the cover 70. The back plate part 73 is gradually inclined to the other side (in the leftward direction in FIG. 10) in the second direction Y toward the rear side from the side on which the side plate part 72 is located. In addition, the cover 70 includes a cross-sectionally arcuate lead-out part 74 protruding rearward from the other end of the back plate part 73 in the second direction Y. As a whole, the cover 70 is open to the front side and the other side in the second direction Y, and is also open to the rear side along the lead-out part 74 at a left end portion of the cover 70. The wires W are covered by the cover 70 at pulled-out portions thereof extending from the rear surface of the housing 20, and are moved toward the other end of the cover 70 in the second direction Y by the back plate part 73. Furthermore, the wires W may be, for example, tapered wound around the lead-out part 74, and be lead out rearward from the lead-out part 74 (see FIG. 2).

As shown in FIGS. 9 and 10, a plurality of cover guide part 75 are formed at a front end portion of each of the opposed plate parts 71 so as to be space apart from each other in the second direction Y. The cover guide parts 75 protrude outward in the up-down direction from the front end portion of the opposed plate part 71 and extend in the front-rear direction. As shown in FIGS. 3 and 4, the cover guide parts 75 are inserted into the guide groove 34 of the housing 20, thus suppressing positional displacement in the front-rear direction.

As shown in FIGS. 9 and 10, an opposed rib 76 extending in the second direction Y is formed at a position near a front end portion of each of the opposed plate parts 71. The opposed rib 76 is disposed rearward of the cover guide parts 75 so as to be opposed to the cover guide parts 75. As shown in FIGS. 2 and 3, the opposed rib 76 is disposed so as to cover the corresponding outer guide rib 28 of the housing 20 from the rear. In addition, each of the opposed plate parts 71 includes a locking part 77 formed between the cover guide parts 75 and the opposed rib 76 in the front-rear direction. Each of the locking parts 77 has a cantilever shape extending inside a notch formed in the corresponding opposed plate part 71 on the other side in the second direction Y, and is elastically deformable in the up-down direction. A locking projection 84 protrudes outward in the up-down direction at a distal end portion of each of the locking parts 77. As shown in FIG. 4, each of the locking projections 84 can be locked to the corresponding stop part 35 of the housing 20.

As shown in FIGS. 9 and 10, a stepped part 78 is formed along the up-down direction at an intermediate portion of each of the opposed plate parts 71 in the front-rear direction. Of portions on opposite sides of the opposed plate part 71 in the front-rear direction with the stepped part 78 interposed therebetween, the rear portion (the portion on the back plate part 73 side) is located inward in the up-down direction relative to the front portion.

A cover lock part 79 protrudes from an outer surface of an intermediate portion of one of the opposed plate parts 71 in the front-rear direction. The cover lock part 79 is formed at the intermediate portion of the opposed plate part 71 in the left-right direction so as to extend from the front portion to the stepped part 78. A pawl-shaped lock body part 81 protrudes rearward from an intermediate portion of the cover lock part 79 in the left-right direction. As shown in FIG. 3, when the lever 40 is at the fitted position, the lock body part 81 is fitted into the lock hole 47 of the lever lock part 45, whereby the lever lock part 45 is locked to the cover lock part 79.

As shown in FIG. 9, protrusions 82 protrude from an outer surface of an intermediate portion of one of the opposed plate parts 71 in the front-rear direction. The protrusions 82 are formed at an intermediate portion of the opposed plate part 71 in the left-right direction so as to extend from the stepped part 78 to the rear portion. The protrusions 82 each have the shape of a plate having a rectangular shape in a side view, and a plate surface thereof is directed in the left-right direction. A pair of protrusions 82 are disposed on opposite side of the opposed plate part 71 in the left-right direction with the cover lock part 79 interposed therebetween. As shown in FIG. 11, the protrusions 82 protrude from the outer surface of the opposed plate part 71 in the first direction X, which is the same direction as the recessed direction of the recesses 52.

### (Operation of Connector 10)

The cover 70 is mounted in a state in which the lever 40 is disposed at the initial position relative to the housing 20. The cover guide parts 75 are inserted into the guide grooves 34 of the housing 20, and the cover 70 is slidably moved relative to the housing 20 from one side in the second direction Y toward the other side. In the process of moving the cover 70, the wires W extending from the rear surface of the housing 20 are pressed by the back plate part 73 and moved toward the lead-out part 74 side.

When the cover 70 has reached the attached position, the locking projection 84 of the locking part 77 of the cover 70 is disposed so as to be lockable to the corresponding stop part 35 of the housing 20 (see FIG. 4), whereby the cover 70 is suppressed from moving toward one side in the second direction Y relative to the housing 20. As a result of the side plate part 72 of the cover 70 coming into contact with an extension portion of the inner guide rib 29 of the housing 20 in the up-down direction, the cover 70 is suppressed from moving toward the other side in the second direction Y relative to the housing 20. Thus, the cover 70 is held at the attached position relative to the housing 20 in a state in which the positional displacement thereof toward the second direction Y is suppressed.

Subsequently, the counterpart connector 100 (not shown) is lightly fitted to the housing 20, and the lever 40 is pivoted from the initial position toward the fitted position. In the process of pivoting the lever 40, the fitting between the connector 10 and the counterpart connector 100 proceeds due to a camming action between the above-described lever 40 and the counterpart connector 100. Immediately before the lever 40 reaches the fitted position, the lever lock part 45 comes int contact with the lock body part 81 of the cover lock part 79 from one side (obliquely above) in the first direction X, and is elastically deformed toward one side in the third direction Z. As shown in FIGS. 2 and 3, when the lever 40 reaches the fitted position, the lever lock part 45 is elastically returned, and the lock body part 81 of the cover lock part 79 is fitted into the lock hole 47. Thus, the lever lock part 45 is disposed so as to be lockable to the cover lock part 79, and the lever 40 is held at the fitted position relative to the cover 70 and the housing 20.

When the lever 40 reaches the fitted position, the recesses 52 of the lever 40 receive the corresponding protrusions 82 of the cover 70 from one side in the first direction X through the receiving openings 56. As shown in FIG. 11, at the fitted position, each protrusion 82 comes into contact with the elastic part 59 formed at the interior of the corresponding recess 52, and the elastic part 59 is elastically deformed toward one side in the third direction Z and comes into contact with the abutment surface 55 to which it is opposed. At the fitted position, the elastic part 59 maintains a state in which the elastic part 59 is elastically deformed by coming into contact with the contact face 83, which is a protruding end portion of the protrusion 82, and the elastic force of the elastic part 59 acts on the lever 40. As a result of the lever 40 being biased toward the other side in the third direction Z by the elastic force of the elastic part 59, the clearances between the lever lock part 45 and the cover lock part 79 is reduced, and the lever lock part 45 is locked to the cover lock part 79 without rattling.

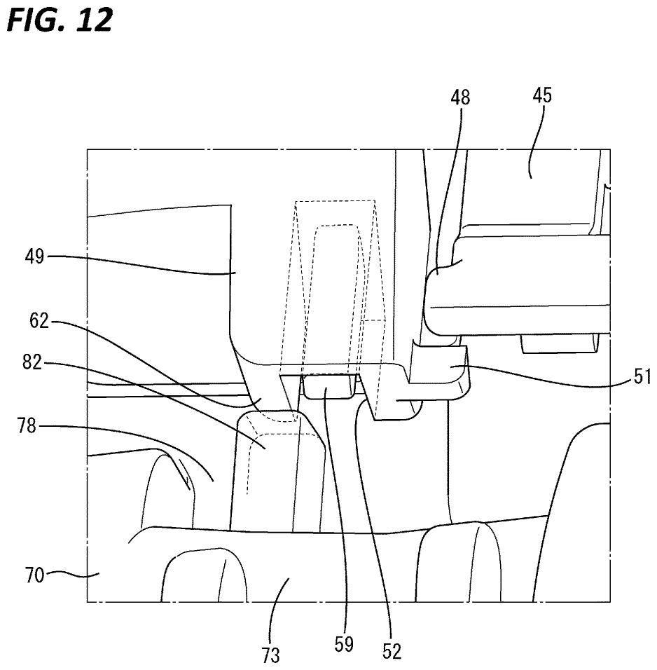

In contrast, when the cover 70 remains at a position before reaching the attached position relative to the housing 20, as shown in FIG. 12, an interference face 62 at an end portion (a peripheral portion of the opening face of the recess 52) of each of the protection walls 49 of the lever 40 interferes with the corresponding protrusion 82 of the cover 70 from one side in the first direction X in the process in which the lever 40 is pivoted from the initial position toward the fitted position, whereby further pivoting of the lever 40 is suppressed. Accordingly, the lever 40 will not reach the fitted position, thus making it possible to detect that the cover 70 has not reached the attached position. In particular, as a result of the interference face 62 of the protection wall 49 interfering with the protrusion 82, it is possible to avoid a situation where the lever lock part 45 is forcibly locked to the cover lock part 79 even though the cover 70 has not reached the attached position. Note that when the cover 70 is at a position away from the attached position, the lever lock part 45 will not reach a position at which the lever lock part 45 can be locked to the cover lock part 79 without the protrusion 82 having to interfere with the interference face 62 of the lever 40. Therefore, a state in which the cover 70 has not reached the attached position can be detected without any problem.

Furthermore, if an operation of pivoting the lever 40 is to be ended at a half-fitted position before the lever 40 reaches the fitted position from the initial position when the cover 70 is at the attached position relative to the housing 20, the elastic parts 59 come into contact with the contact faces 83 of the protrusions 82, and the lever 40 is pushed back to the initial position by the reactive force of the elastic parts 59. Here, by a worker confirming the push back (force back, reactive force) of the lever 40 to the initial position, it is possible to detect that the lever 40 has not reached the fitted position.

As described thus far, the connector 10 according to Embodiment 1 includes the housing 20, the cover 70 that covers the wires W extending from the housing 20, and the lever 40 that is supported so as to be pivotable from the initial position to the fitted position in the first direction X relative to the housing 20. The lever 40 includes the lever lock part 45 capable of being locked to the housing 20 at the fitted position. The cover 70 is slid on and attached to the housing 20 in the second direction Y that intersects the first direction X, and includes the locking parts 77 capable of being locked to the housing 20 at the attached position. The lever 40 includes the recesses 52 recessed in the first direction X. The cover 70 includes the protrusions 82 protruding in the first direction X Each of the protrusions 82 is disposed at an interior portion of the corresponding recess 52 at the attached position and the fitted position. Furthermore, the lever 40 includes the elastic parts 59 that come into contact with the corresponding contact faces 83 of the cover 70 while reaching the fitted position from the initial position.

If the cover 70 has reached the attached position relative to the housing 20, and the lever 40 remains at a position midway from the initial position to the fitted position, the elastic parts 59 come into contact with the corresponding contact faces 83 of the cover 70, and the lever 40 is pushed back by the elastic force of the elastic parts 59. By the worker confirming this state, it is possible to detect that the lever 40 is at the half-fitted state in which the lever 40 has not reached the fitted position.

In particular, the elastic parts 59 are provided at the interior portions of the corresponding recesses 52, and come into contact with the corresponding protrusions 82 while reaching the fitted position from the initial position. Accordingly, it is possible to suppress an increase in size and complexity of the shape of the cover 70 on which the elastic parts 59 are provided. Moreover, the elastic parts 59 are less likely to come into contact with an external foreign object at the interior portions of the recesses 52, thus making it possible to prevent a situation where the elastic force of the elastic parts 59 is impaired.

The abutment surfaces 55 that come into contact with the elastic part 59 at the attached position and the fitted position is provided on the innermost side in the first direction X of the interior portion of each of the recesses 52. As a result of the elastic part 59 coming into contact with the abutment surface 55, further elastic deformation of the elastic part 59 can be suppressed, thus making it possible to more reliably prevent a situation where the elastic force of the elastic part 59 is impaired.

In the case of Embodiment 1, the elastic parts 59 each have a shape extending in the third direction Z that intersects the first direction X and the second direction Y. One end of each of the elastic parts 59 in the third direction Z is fixed to the one face 57 of the recess 52, and the other end of the elastic part 59 in the third direction Z is a free end. The other end face of each of the recesses 52 that is opposed to the one face 57 is open as the open face 58. With this configuration, the elastic part 59 can be molded without undercut using a mold that moves from the open face 58 toward the other side in the third direction Z.

Furthermore, the elastic parts 59 are provided on opposite sides of the lever 40 in the left-right direction with the lever lock part 45 interposed therebetween as viewed from the first direction X, the lever 40 at the fitted position is biased in a direction in which the locking to the cover 70 is strengthened. Accordingly, the lever lock part 45 is locked to the cover 70 without rattling.

### Other Embodiments of the Present Disclosure

It should be appreciated that Embodiment 1 presently disclosed is in all respects illustrative and not limiting.

In the case of Embodiment 1 described above, the protrusions 82 are provided on the cover 70, and the recesses 52 are provided on the lever 40. In contrast, according to other embodiments, the protrusions may be provided on the lever, and the recesses may be provided on the cover.

In the case of Embodiment 1 described above, the elastic parts 59 are provided on the lever 40. In contrast, according to other embodiments, the elastic parts may be provided on the cover.

In the case of Embodiment 1 described above, each of the elastic parts 59 is provided at an interior portion of the corresponding recess 52. In contrast, according to other embodiments, each of the elastic parts may be provided at a portion of the lever or the cover that is other than the recess. For example, the elastic part may be independently provided at a position of the lever that is away from the corresponding protection wall. The elastic part may be provided at a distal end portion of the corresponding protrusion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing;
a cover configured to cover a wire extending from the housing; and
a lever configured to be supported so as to be pivotable in a first direction from an initial position to a fitted position relative to the housing, wherein
the lever includes a lever lock part capable of being locked to the housing at the fitted position,
the cover is slid on and attached to the housing in a second direction that intersects the first direction, and includes a locking part capable of being locked to the housing at an attached position,
one of the lever and the cover includes a recess recessed in the first direction, and the other of the lever and the cover includes a protrusion protruding in the first direction,
the protrusion is disposed at an interior portion of the recess at the attached position and the fitted position, and
one of the lever and the cover includes an elastic part that comes into contact with the other of the lever and the cover while reaching the fitted position from the initial position.

2. The connector according to claim 1, wherein
the elastic part is provided at one of the interior portion of the recess and a distal end portion of the protrusion, and comes into contact with the other of the interior portion and the distal end portion while reaching the fitted position from the initial position.

3. The connector according to claim 2, wherein
the elastic part is provided in the interior portion of the recess.

4. The connector according to claim 3, wherein
an abutment surface that comes into contact with the elastic part at the attached position and the fitted position is provided on an innermost side of the interior portion of the recess in the first direction.

5. The connector according to claim 3, wherein
the elastic part has a shape extending in a third direction that intersects the first direction and the second direction,
one end of the elastic part in the third direction is fixed to one face of the recess,
another end of the elastic part in the third direction is a free end, and
another end face of the recess that is opposed to the one face is open as an open face.

6. The connector according to claim 1, wherein
the elastic parts are provided on opposite sides of the lever with the lever lock part interposed therebetween as viewed in the first direction.
